(19) United States
(12) Patent Application Publication
(10) Pub. No.: US 2011/0078938 A1
(43) Pub. Date: Apr. 7, 2011

(54) Submerged Fishing Rod Location Detection Device & Retrieval Instrument

(76) Inventor: Joseph Aguzin, Metairie, LA (US)

(21) Appl. No.: 12/781,011

(22) Filed: May 17, 2010

Related U.S. Application Data
(60) Provisional application No. 61/248,507, filed on Oct. 5, 2009.

(51) Int. Cl. A01K 97/00; A01K 97/12; B63B 22/10; A01K 87/00

(52) U.S. Cl. 43/25; 441/8

(57) ABSTRACT

A retriever and location marker device created for but not limited to fishing rods. Invention is fastened to a fishing rod for precautionary measures in the unfortunate accident of rod being dropped overboard and/or becoming submerged. Device has minimal impact concerning balance and action of the rod. Device is mounted, incorporated, attached, or connected to rod handle. This device consists of a fastener with automatic extender, floatation device, water splash shield, and specialized water-soluble material which deteriorates upon submersion in water. Device is particularly created to facilitate the needs of fishermen but not limited to only fishing rods or fishermen. This device can be attached to other items where the same end result can be achieved.

The present application claims priority to U.S. Provisional Patent Application No. 61/248,507, filed Dec. 20, 2009, which is incorporated herein by reference.

### BACKGROUND OF THE INVENTION

1. Field of the Invention

The present application relates to devices for marking and retrieving articles which have been dropped and/or placed below the water line.

2. Description of the Related Art

A number of devices have been proposed for locating items dropped or otherwise placed below the water line, such as those disclosed in U.S. Pat. Nos. 2,198,755, 2,479,021, 2,479,098, 2,528,799, 2,531,586, 2,539,548, 2,588,637, 2,675,568, 2,723,404, 2,783,731, 2,785,420, 2,791,785, 2,806,231, 2,821,725, 2,941,217, 2,968,819, 3,049,733, 3,313,268, 3,982,294, 4,126,907, 4,290,159, 4,583,314, 4,619,066, 4,713,031, 4,766,690, 5,156,562, and 5,203,104, each of which is incorporated herein by reference. All of these devices, however, lack fundamentals like being obstruction-free, cost effective, visually pleasing, and non-affecting rod performance. Other differences are logic, complexity, and user-friendliness.

One reason that the devices in the related art haven't been marketed and manufactured is because of the cost, lack of logical functionality, and complexity. U.S. Pat. No. 5,156,562, for example, has multiple problems. The device hangs from the rod which affects the balance and the action that the rod is designed for. With many parts, it is also complex to produce. Another example is U.S. Pat. No. 4,709,500, which provides a device that attaches itself to the entire shaft, which restricts vibration and sensitivity which is a vital part of the rods sensitivity and action. It also has potential to obstruct the fishing line since float is bulky. Lastly, U.S. Pat. No. 3,210,785 provides a device that is dangerous, complex and affects balance. This item has pressure which can explode. It is also made of metal which has significantly more weight than other materials.

In summary, similar devices disclosed in the patents noted above place weight and obstruction in vital areas which affect the performance and action of the specially designed rods. Others are complex and bulky. Many of the other similar devices have more than several action component parts which make the devices complex, expensive, and difficult to manufacture. Other similar devices are connected, attached, mounted or incorporated in certain ways which make the rods unbalanced which alters its performance. The alteration of the sleek rod design works adversely to the rod action. Flow plan and design of rod is compromised because items are bulky. Anglers purchase expensive rods which rely on the streamline structure and sensitivity. Accordingly, there is a need for a device for marking and/or retrieving submerged items, such as fishing rods, that is not subject to one or more of the limitations noted above.

### SUMMARY OF INVENTION

The present application generally provides a device that is in the category of a float, alert and for retrieval of submerged items. This device is described as an assembly mechanism which protects from the loss of fishing rods by alerting a person of the location of a submerged rod and allows retrieval of the submerged item.

The submerged fishing rod location detection & retrieval device, hereinafter the device, is generally connected to the handle of the rod. A possible sample scenario but not limited to, would be, while fishing, the angler accidentally drops his fishing rod and the rod becomes submerged below water line. The action of the device now begins. Within 15 minutes or some other time frame the water shield attached to the device will become disconnected from the device due to the deterioration of a water-soluble material that connects the shield to the device, which when disconnected will expose the compressed float and cord. The compressed float will expand and become buoyant. The float then begins to rise to the water surface because it is a floatable material. The float is attached to the cord and while the float is rising it is stretching the cord which is systematically spun to avoid tangle. The cord further attaches to the clamp portion of the device that attaches the device to the rod. Therefore, when the float item surfaces, the angler will have connectivity to their submerged rod. Fastener and cord are strong and can support weight of emerging fishing rod.

The device provides a simple cost effective logical design which doesn't affect the performance of rods. Fishing rods are expensive and anglers are always worried about losing their rod by accidentally dropping them in water. The device of the present application is great for new fishermen or present outdoorsmen, and a great item to have on hand in case your friend forgets or loses his fishing rod and wants to use one of yours. The device of the present application is a great precautionary device to protect your investment. The device will also provide the ability to retrieve a person's submerged fishing rod.

The device of the present application is light, logical and effective. It is light in weight because it is preferably made of plastic, foam, water-soluble materials and a cord. These materials are minimal in weight. The device is designed to connect to the rod handle in the area under the fishing reel or an area designated for the fishing reel. Its logical action is important in the area where systematic layered capsule design is unique. It is a simple logical design with sequential layering which makes functionality inevitable.

### BRIEF DESCRIPTION OF THE DRAWINGS

FIG. 1 is a perspective view of the submerged fishing rod location detection device and retrieval instrument according to one embodiment of the devices disclosed herein.

FIG. 2 is a perspective view of a detection device in an open position.

FIG. 3 is a perspective view of a device in a further open position.

FIG. 4 is a perspective view of a device in another open position.

FIG. 5 is an elevation view of a fishing rod with a device installed.

FIG. 6 is an elevation view of a submerging fishing rod with a device beginning to open.

FIG. 7 is an elevation view of a submerging fishing rod with released float elevating.

FIG. 8 is an elevation view of a submerged fishing rod with a surfaced float.

FIG. 9 is a perspective view of a retrieval device according to another embodiment of the devices disclosed herein.

FIG. 10 is a perspective view of a retrieval device in use.

FIG. 11 is a perspective view of another embodiment of the devices disclosed herein.

FIG. 12 is a section view of a retrieval device according to at least one embodiment showing the float, cord, and fastener arranged in a layered construction encapsulated in a water soluble material.

FIG. 13 is another perspective view of a retrieval device in use.

### COMPONENT REFERENCE NUMBERS

14 fastener
16 rod
18 cord
20 float
22 water soluble material
24 device
26 cord bundle
28 float bundle
30 cap/splash shield

### DETAILED DESCRIPTION

The present application relates to floatation devices, and more particularly to a submersed rod location alert and retrieving devices.

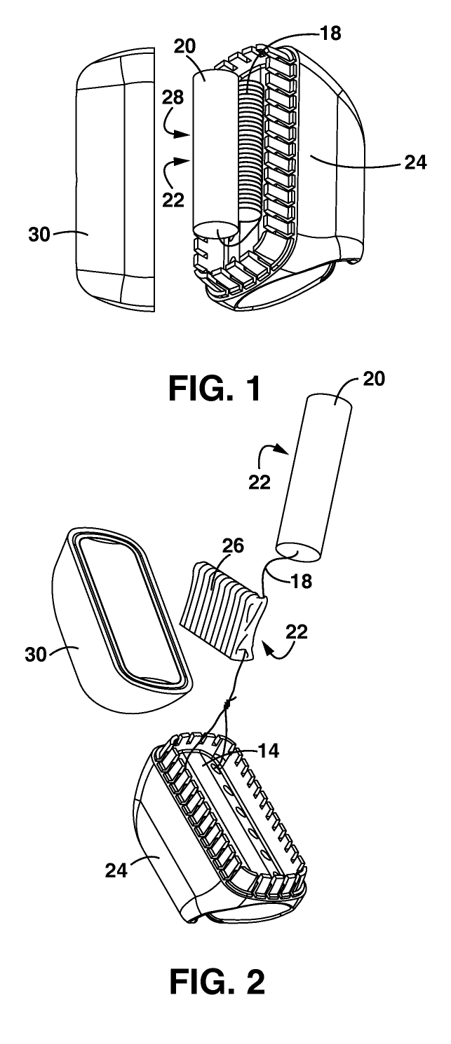

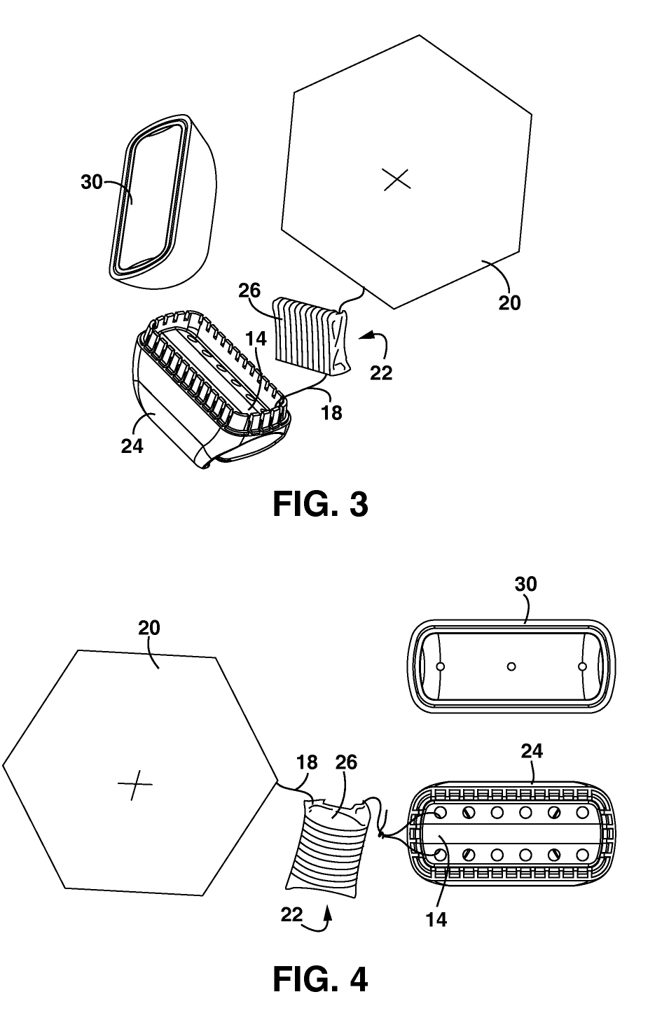

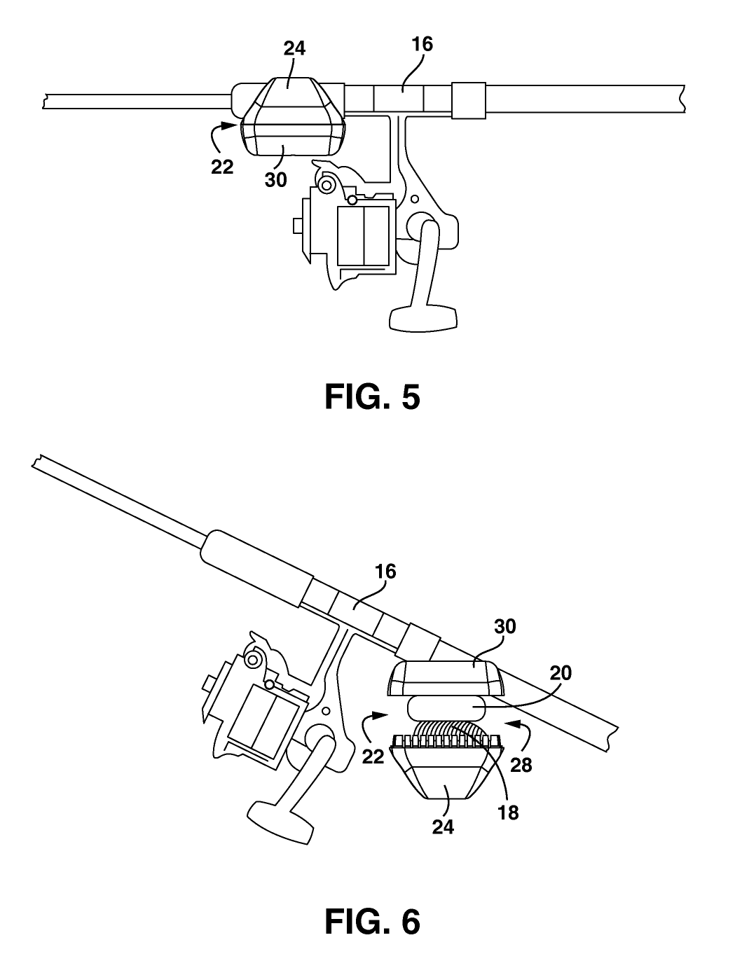

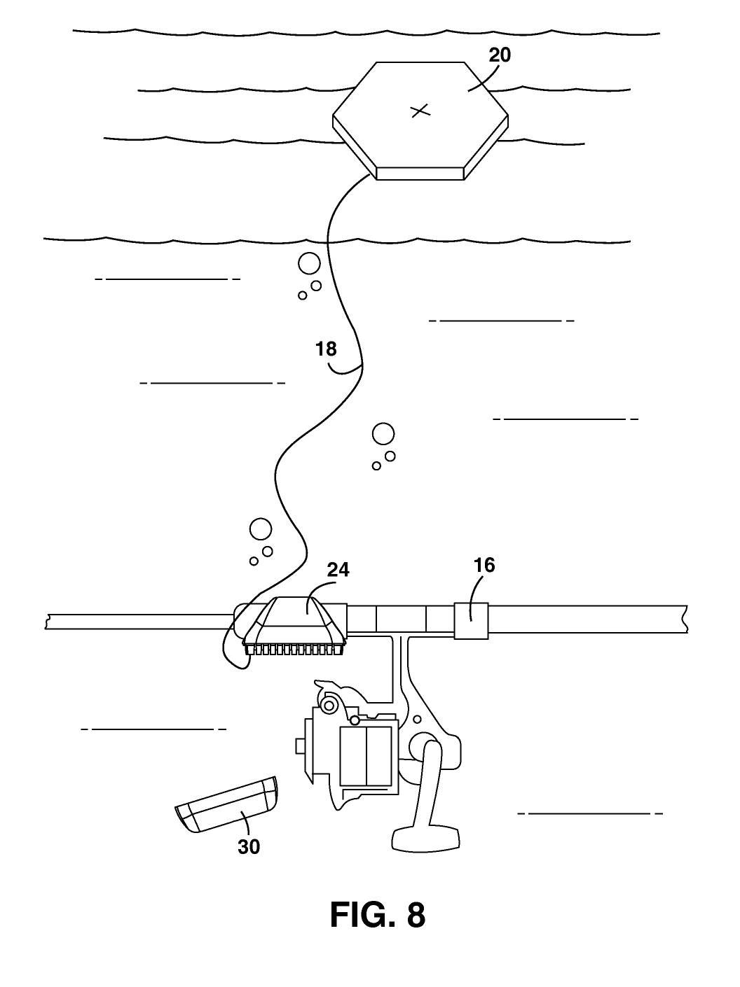

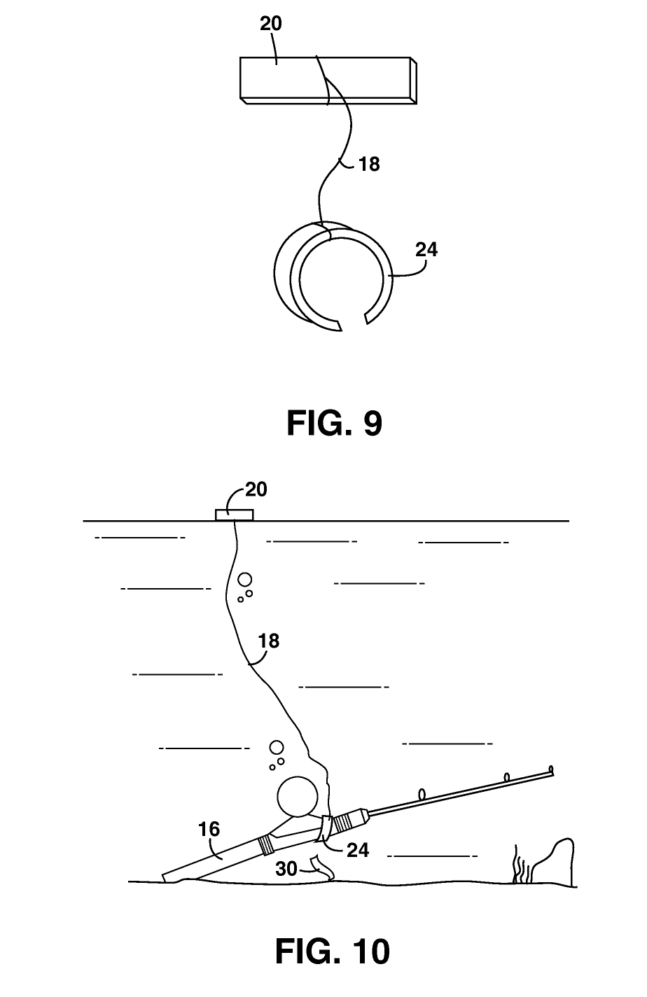

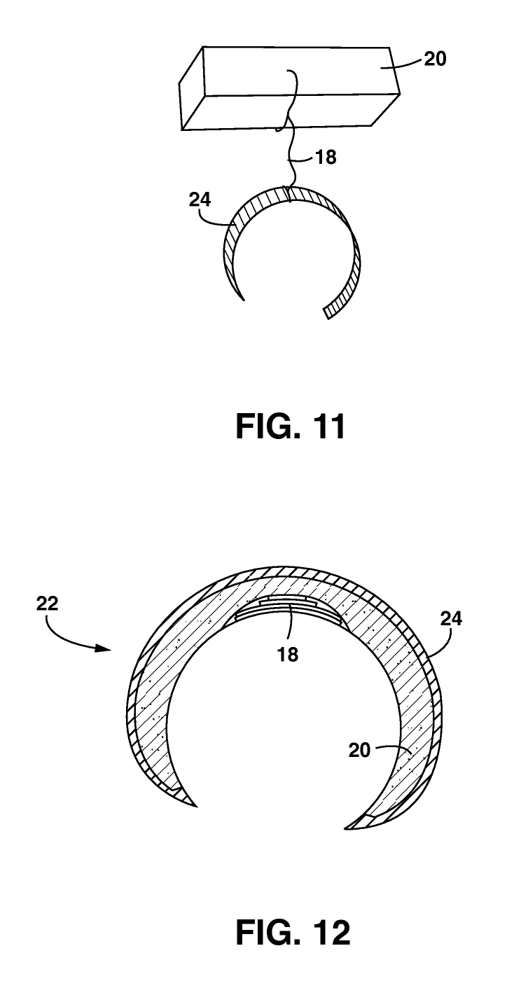

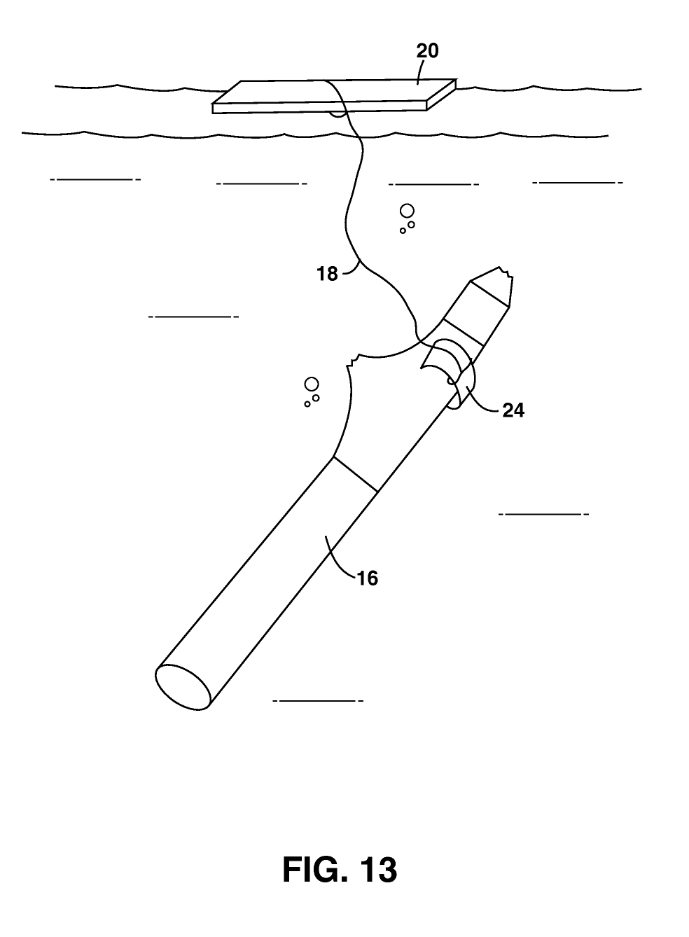

Referring to FIGS. 1-13, the device 24 includes a fastener 14 that connects and grips onto rod 16 handle near the reel of the rod, as shown in FIGS. 5-6, 10, and 13. The device further includes a perfectly spun lock of cord 18 or cord bundle 26 where one end of the cord 18 is tied to the fastener 14 and the other to the float 20. This creates a bond between fastener 14 and the float 20. When the device 24 of the present application is connected to a rod 16, the rod 16 will have a long cord 18 with a float device 20 connected to it. The extended median cord 18 gives a person the ability to see the alert float 20 and ultimately retrieve the rod 16. If the rod 16 is sitting at bottom of river, lake, ocean or any other body of water, the device's protection security plan will begin by deteriorating a water-soluble material 22 which bonds the water splash shield/cap 30, and encapsulates the float 20, cord 18, and fastener 14. As the water-soluble material 22 deteriorates, the cap 30 will be released from the device 24, which will cause the items therein to become exposed and the float 20 material will rise to the surface of the water where an angler can be alerted of the rod's location.

The float 20 of the device may be compressed and wrapped with a water soluble material. The systematically spun cord bundle 26 may also be wrapped with a water-soluble material. The float 20 and cord bundle 26 may be layered in a specific sequence, as shown in FIG. 12, for easy disengagement from the device. The water-soluble material 22 may cover the float bundle 28 and fastener 14 and it provides adhesive to connect the water splash shield/cap 30 to the device 24. The water shield/cap 30 is placed on top of the layered system to protect the water soluble material from minute amounts of water. As shown in FIG. 12, the device is a set of relatively thin layers formed into semicircular collar that fits over the rod 16.

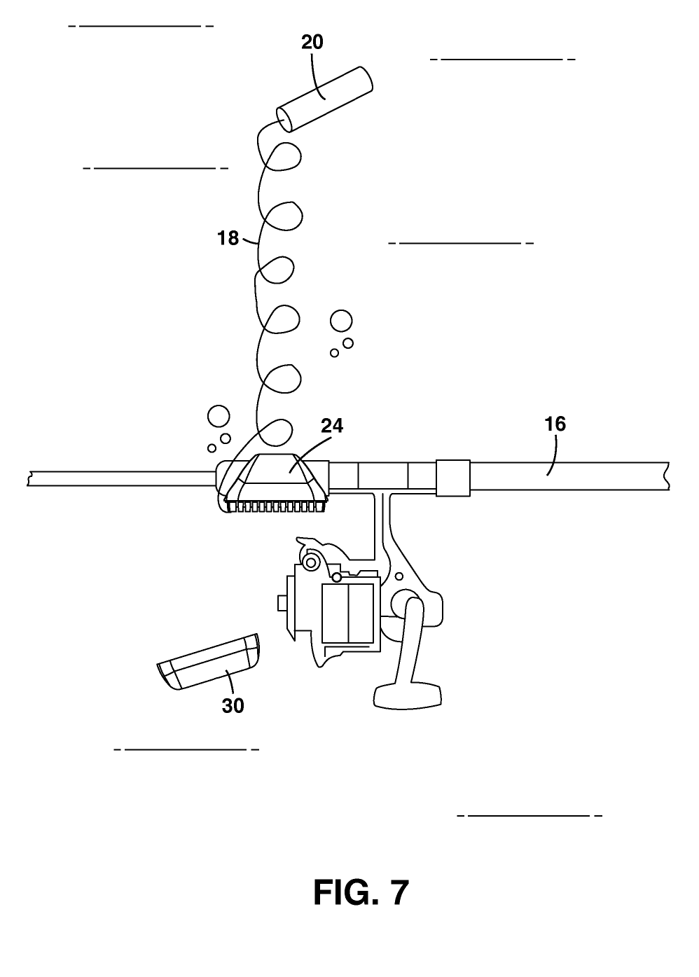

The fastener 14 of the device 24 is a semi circle fastener which is rigid but flexible enough to snap onto handle of fishing rods. One end of cord 18 is tied around the fastener 14 and the other end of the cord 18 to the float 20. This makes the connectivity from the fastener 14 to the float device 20. At this point the working product is exposed, meaning if you connect the fastener 14 to the rod 16 handle then submerge the rod 16 below water, you will have the rod 16 at the bottom of the water and the float 20 will be on surface of the water, as shown in FIG. 7 and FIG. 10. Meaning it will get attention from person looking in the area. You can grab the float 20 and pull the line 18 which is attached to rod 16 via the fastener 14. The rod will emerge out of the water.

For the invention to function properly specific needs are required. The cord 18 is preferably systematically spun so entanglement doesn't occur when stretching. After the cord 18 is spun, the cord 18 is wrapped in a water-soluble material leaving a spool with two loose ends. One end is located at the bottom of the spool and the other end is located at the top of the spool. One end is carefully connected to the float 20 by tying a knot or otherwise. The float 20 is then rolled, but not limited to only rolling, into a bundle 28. The bundled float 28 is wrapped with water-soluble material. At this point the bundled sponge 28 is connected to the bundle of cord 26. The other end of cord is tied to the fastener 14. This creates the bond between the float and fastener 14 and thus the device 24. The items are systematically layered by beginning from ground up it will begin with the fastener item 14 then the bundle of cord 26, next the bundled float 28 followed by water-soluble material 22 to encapsulate items and lastly the water splash shield/cap 30 is connected to protect against miniscule amounts of water. Water-soluble material is used to encapsulate the float, cord, and fastener which when activated, the water-soluble material 22 will deteriorate. A cap 30 covers the water-soluble material 22, float 20, line 18 and fastener 14. Water-soluble material will withstand weathering by nature's elements but deteriorates when submerged under water.

The device 24 may be assembled as follows:

Phase 1—spin cord in a symmetrical layering method.

Phase 2—layer water soluble material around spun cord.

Phase 3—remove spun cordage from spinning device by sliding off, collapse cordage and wrap in water soluble material. Don't roll but fold water soluble material so it stays in the form of the collapsed line.

Phase 4—tie spun cordage package to float item.

Phase 5—compress float and wrap in water soluble material.

Phase 6—tie other side of cord to clamp.

Phase 7—stack float bundle and cord bundle on plastic fastener, place wet water soluble material over stacked items then place water splash cap to cover.

Phase 8—fill in crevices with water soluble material.

The water soluble material is any material capable of creating a bond between the fastener and cover. By placing water soluble material on the edge where the fastener and cover meet, it provides an adhesive which secures the cover to the fastener. Because the adhesive is soluble, it will dissolve when submerged under water. When the water soluble material is dissolved, it releases the bond between the fastener and cover. In-turn it allows layered design to become activated.

While the foregoing invention has been described in some detail for purposes of clarity and understanding, it will be appreciated by one skilled in the art, from a reading of the disclosure, that various changes in form and detail can be made without departing from the true scope of the invention.

1-20. (canceled)

21. A device for locating and retrieving submerged items comprising:
a fastener for removably connecting the device to a handle of a fishing rod;
a float; and
a cord having a first end attached to the fastener and a second end attached to the float, wherein the cord is wound into a bungle and layered between the fastener and the float, and wherein the float and cord are encapsulated with a water soluble material that is activated when submerged in water and the float is released from the device.

22. The device of claim 21, wherein the fastener has a semicircular shape.

23. The device of claim 22, wherein the cord is layered over the semicircular fastener and the float is compressed and layered over the cord and the fastener.

24. The device of claim 23, wherein the device has a semicircular shape.

25. The device of claim 24, comprising a water shield disposed over the cord and float.

26. The device of claim 25, wherein the water shield is adhered to the device with the water soluble material.

27. The device of claim 26, wherein when submerged the water soluble material deteriorates, releases the water shield from the device, and exposes the float and the cord.

28. The device of claim 27, wherein when the float and the cord are exposed to the water, the water soluble material encapsulating the float and the cord further deteriorates releasing and allowing the float to rise in the water to the surface.

29. The device of claim 27, wherein the water shield encloses the float and the cord, and the fastener and the water shield include pores for water to enter the device when submerged.

30. A device for locating and retrieving submerged items comprising:
a semicircular fastener for removably connecting the device to a handle of a fishing rod;
a compressed float;
a cord having a first end attached to the fastener and a second end attached to the float; and
a water shield disposed over the cord and the float, wherein the cord is wound into a bungle and layered between the fastener and the compressed float, and wherein the float and cord are encapsulated with a water soluble material that deteriorates when submerged in water and releases the water shield and the float from the device allowing the float to rise in the water to the surface.
